(19) United States
(12) Patent Application Publication
(10) Pub. No.: US 2003/0077038 A1
(43) Pub. Date: Apr. 24, 2003

(54) Optical component, Optical encoder, Optical decoder, and Optical communication system

(76) Inventors: Kiyotaka Murashima, Yokohama-shi (JP); Toshikazu Shibata, Yokohama-shi (JP); Akira Inoue, Yokohama-shi (JP)

Correspondence Address: MCDERMOTT WILL & EMERY, 600 13TH STREET, N.W., WASHINGTON, DC, 20005-3096, US

(21) Appl. No.: 10/228,265

(22) Filed: Aug. 27, 2002

(30) Foreign Application Priority Data
Aug. 27, 2001 (JP) 2001-256786
Apr. 17, 2002 (JP) 2002-115061

(51) Int. Cl. G02B 6/34; G02B 6/26

(52) U.S. Cl. 385/37; 385/15

(57) ABSTRACT

An optical communication system comprises an optical circulator and an optical component. The optical circulator has first, second, and third ends, outputs from the second end light fed into the first end, and outputs from the third end light fed into the second end. The optical component includes an optical waveguide type diffraction grating device connected to the second end of the optical circulator and provided with a plurality of refractive index modulation forming areas, disposed along the longitudinal direction of an optical fiber, for Bragg-reflecting a predetermined wavelength of guided wave. A predetermined region including the boundary position between two refractive index modulation forming areas adjacent each other in the optical waveguide type diffraction grating device is heated by a thin film heater, so as to adjust the optical path length thereof.

### BACKGROUND OF THE INVENTION

1. Field of the Invention

The present invention relates to an optical communication system for transmitting and receiving signal light while encoding it, an optical encoder/decoder for encoding/decoding signal light in the optical communication system, and an optical component used in the optical encoder/decoder.

2. Related Background Art

While optical communication systems can transmit a large volume of information at a high speed, they are still desired to have a greater capacity. For attaining a greater capacity, the time division multiplexing transmission (TDM), in which signal light having the same wavelength is divided with time so as to allocate a number of channels for carrying out multiplexed transmission, and the wavelength division multiplexing transmission (WDM), in which a given wavelength band is divided with predetermined frequency intervals so as to allocate a number of channels for carrying out multiplexed transmission, have conventionally been carried out.

On the other hand, attention has recently been given to the optical code division multiplexing (OCDM) transmission. In the OCDM transmission, different codes are prepared for respective channels, signal light is encoded with these codes, and thus encoded signal light is sent out from an optical transmitter. In response to thus encoded signal light, an optical receiver decodes the signal light with the same code as that used upon transmission, and receives thus decoded signal light.

When the code used upon transmission is the same as that used upon reception, their correlation peak is so large that the optical receiver reconstitutes the original signal light by comparing the peak value with a certain threshold. If the code used upon transmission differs from that used upon reception, by contrast, their correlation peak is so small that the result of encoding yields noise in the optical receiver, whereby the original signal light will not be reconstituted.

Such OCDM transmission not only can expand the transmission capacity, but also can achieve a simple and flexible system configuration without requiring the synchronization between stations, and improve the communication security. Also, by preparing respective codes for individual channels, the OCDM transmission can transmit a number of channel signals by using one wavelength, thus being able to achieve a hybrid configuration with the WDM transmission scheme, which can further expand the transmission capacity.

The encoding/decoding process in the optical transmitter/receiver is carried out either electrically or optically. Also, various schemes have been proposed concerning the optical encoding/decoding process. For example, the optical encoder/decoder disclosed in P. C. Teh, et al., “The generation, recognition and re-coding of 64-bit, 160 Gbit/s optical code sequences using super structured fiber Bragg gratings”, OECC2000 Technical Digest, PD1-3 (2000) includes a plurality of optical circulators cascaded to each other and Bragg grating devices provided so as to correspond to the respective optical circulators, and encodes/decodes signal light by utilizing the Bragg reflection of light in the Bragg grating devices.

However, the optical encoder/decoder disclosed in the above-mentioned literature has a large-size configuration since it includes a plurality of sets of optical circulators and Bragg grating devices. Also, since codes are fixed in the optical encoder/decoder disclosed in the above-mentioned literature, a transmitter/receiver must be provided with optical encoders/decoders by the same number of channels.

### SUMMARY OF THE INVENTION

For overcoming the problems mentioned above, it is an object of the present invention to provide an optical encoder/decoder which is small in size while making codes variable, an optical component used in the optical encoder/decoder, and an optical communication system carrying out optical communications by using the optical encoder/decoder.

The optical component in accordance with the present invention comprises (1) an optical waveguide type diffraction grating device successively provided with first to N-th refractive index modulation forming areas, each Bragg-reflecting a predetermined wavelength of guided wave, along a longitudinal direction of an optical waveguide; and (2) optical path length adjusting means for adjusting an optical path length of a predetermined region including a part of a region between the n-th and (n+t)-th refractive index modulation forming areas. Here, N is an integer of at least 2, whereas n is an integer of at least 1 but not greater than (N−1). When the n-th and (n+1)-th refractive index modulation forming areas are in contact with each other, a part of the region therebetween refers to the boundary position therebetween. Preferably, the optical path length adjusting means adjusts the optical path length of a predetermined region in the optical waveguide type diffraction grating device by regulating the temperature or tension in the predetermined region. Preferably, the optical path length adjusting means adjusts the optical path length of a predetermined region in the optical waveguide type diffraction grating device by regulating the refractive index of a refractive index variable member provided in the predetermined region. Preferably, a predetermined region in the optical waveguide type diffraction grating device is formed with no refractive index modulation or deviates from a position where the refractive index modulation is maximized in the first to N-th refractive index modulation forming areas.

In the optical component, the optical path length of a predetermined region including a part of the region between the n-th and (n+1)-th refractive index modulation forming areas adjacent each other in the first to N-th refractive index modulation forming areas in the optical waveguide type diffraction grating device is adjusted by the optical path length adjusting means, whereby the respective optical path lengths of the n-th and (n+1)-th refractive index modulation forming areas adjacent each other can be changed by a half-integer multiple of wavelength.

The optical encoder or decoder in accordance with the present invention comprises (1) an optical circulator having first, second, and third ends, outputting from the second end light fed into the first end, and outputting from the third end light fed into the second end; and (2) the optical component in accordance with the present invention connected to the second end of the optical circulator. The optical encoder in accordance with the present invention encodes the signal light fed into the first end of the optical circulator and outputs thus encoded signal light from the third end of the optical circulator. The optical decoder in accordance with the present invention decodes encoded signal light fed into the first end of the optical circulator and outputs thus decoded signal light from the third end of the optical circulator.

In the optical encoder, pulsed light fed into the first end of the optical circulator is outputted from the second end, and is reflected by each of the first to N-th refractive index modulation forming areas in the optical waveguide type diffraction grating device of the optical component connected to the second end. The first to N-th pulsed light components respectively reflected by the first to N-th refractive index modulation forming areas are fed into the second end of the optical circulator and then are outputted from the third end. Here, in the optical waveguide type diffraction grating device of the optical component, the optical path length of a predetermined region including a part of the region between the n-th and (n+1)-th refractive index modulation forming areas in the first to N-th refractive index modulation forming areas is adjusted by the optical path length adjusting means. Therefore, in the optical encoder, the outputted first to N-th pulsed light components are those obtained upon encoding the pulsed light inputted, whereas the code at that time corresponds to the phase inversion based on the optical path length of the predetermined region adjusted by the optical path length adjusting means. In the optical decoder, on the other hand, the first to N-th pulsed light components outputted from the optical decoder are inputted and decoded. If the same code is used for encoding and decoding processes in the optical encoder and decoder, a greater correlation peak appears in the optical decoder.

The optical communication system in accordance with the present invention comprises (1) an optical transmitter having the optical encoder in accordance with the present invention, encoding signal light with the optical encoder, and sending out thus encoded signal light; and (2) an optical receiver having the optical decoder in accordance with the present invention, decoding encoded signal light having arrived, and receiving thus decoded signal light. This optical communication system can carry out the OCDM transmission since it comprises an optical transmitter having the optical encoder in accordance with the present invention, and an optical receiver having the optical decoder in accordance with the present invention.

### BRIEF DESCRIPTION OF THE DRAWINGS

FIG. 1 is a diagram showing the optical encoder in accordance with an embodiment;

FIGS. 2A and 2B are explanatory views for the optical component in accordance with an embodiment;

FIGS. 3A and 3B are charts showing states of refractive index modulation in the optical waveguide type diffraction grating device of the optical component in accordance with the embodiment;

FIG. 4 is a diagram of the optical communication system in accordance with an embodiment;

FIG. 5 is a chart showing respective waveforms of light outputted from the modulator, optical encoder, optical decoder, and gate circuit in the optical communication system in accordance with the embodiment;

FIGS. 6A to 6D are charts showing a refractive index modulation distribution, a transmission characteristic, a pulse response waveform, and a correlation waveform in the optical waveguide type diffraction grating device of an optical component 120;

FIGS. 7A to 7D are charts showing a refractive index modulation distribution, a transmission characteristic, a pulse response waveform, and a correlation waveform in the optical waveguide type diffraction grating device of the optical component;

FIGS. 8A to 8D are charts showing a refractive index modulation distribution, a transmission characteristic, a pulse response waveform, and a correlation waveform in the optical waveguide type diffraction grating device of the optical component;

FIGS. 9A to 9D are charts showing a refractive index modulation distribution, a transmission characteristic, a pulse response waveform, and a correlation waveform in the optical waveguide type diffraction grating device of the optical component;

FIGS. 10A to 10D are charts showing a refractive index modulation distribution, a transmission characteristic, a pulse response waveform, and a correlation waveform in the optical waveguide type diffraction grating device of the optical component;

FIGS. 11A and 11B are explanatory views for the optical component in accordance with another embodiment;

FIG. 12 is a graph showing the relationship between the tension Δg for realizing the phase inversion and the length d of a predetermined region in the optical component in accordance with the above-mentioned embodiment; and

FIG. 13 is an explanatory view for the optical component in accordance with still another embodiment.

### DESCRIPTION OF THE PREFERRED EMBODIMENTS

In the following, embodiments of the present invention will be explained in detail with reference to the accompanying drawings. In the explanation of the drawings, constituents identical to each other will be referred to with numerals identical to each other without repeating their overlapping descriptions.

First, embodiments of the optical component, optical encoder, and optical decoder in accordance with the present invention will be explained.

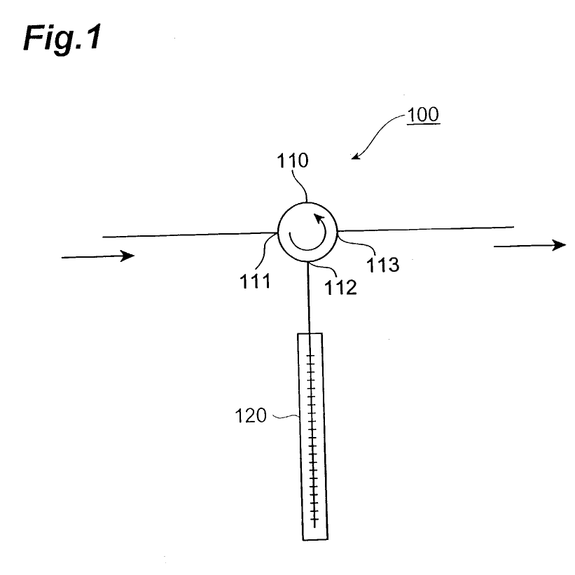

FIG. 1 is a diagram of the optical encoder 100 in accordance with an embodiment. This optical encoder 100 comprises an optical circulator 110 and the optical component 120 in accordance with an embodiment. The optical circulator 110 has a first end 111, a second end 112, and a third end 113, outputs from the second end 112 light fed into the first end 111, and outputs from the third end 113 light fed into the second end 112. The optical component 120 includes an optical waveguide type diffraction grating device connected to the second terminal 112 of the optical circulator 110 and provided with refractive index modulation forming areas, extending along the longitudinal direction of an optical fiber acting as an optical waveguide, for Bragg-reflecting a specific wavelength of guided wave. This optical encoder 100 inputs unencoded signal light to the first end 111 of the optical circulator 110, encodes this signal light, and outputs thus encoded signal light from the third end 113 of the optical circulator 110.

The optical decoder in accordance with this embodiment has the same configuration as that of the optical encoder 100 shown in FIG. 1, inputs encoded signal light to the first end 111 of the optical circulator 110, decodes this signal light, and outputs thus decoded signal light from the third end 113 of the optical circulator 110.

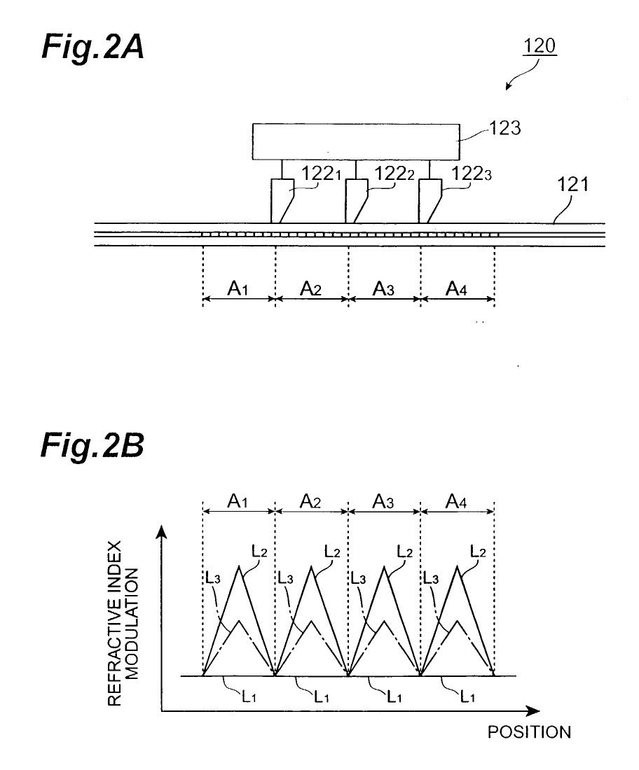

FIGS. 2A and 2B are explanatory views for the optical component 120 in accordance with this embodiment. The optical component 120 comprises an optical waveguide type diffraction grating device 121, thin film heaters 122₁ to 122₃, and a temperature controller 123. FIG. 2A shows the configuration of the optical component 120. FIG. 2B shows a state of refractive index modulation in the optical waveguide type diffraction grating device 121. The optical waveguide type diffraction grating device 121 is provided with first to fourth refractive index modulation forming areas A₁ to A₄, successively disposed along the longitudinal direction of an optical fiber acting as an optical waveguide, for Bragg-reflecting a specific wavelength of guided wave. In each of the refractive index modulation forming areas A₁ to A₄, the core region is formed with a predetermined period of refractive index modulation, such that the amplitude of refractive index modulation is smaller as the location is longitudinally farther from the center position, so as to become zero at boundary positions. FIG. 2B shows lines L₁ connecting minimal points of refractive index modulation, lines L₂ connecting maximum points of refractive index modulation, and lines L₃ indicating the distribution of average refractive index when there is no temperature change.

The thin film heaters 122₁ to 122₃ and the temperature controller 123 act as optical path length adjusting means for adjusting the optical path length of a predetermined region including the boundary position between the refractive index modulation forming areas Aₙ and Aₙ₊₁ in the optical waveguide type diffraction grating device 121 (n=1 to 3). Namely, each thin film heater 122ₙ is a thin film, made of Cr, for example, having a thickness of several tens of micrometers, whereas an end part thereof is in contact with a predetermined region including the boundary position between the refractive index modulation forming areas Aₙ and Aₙ₊₁ in the optical waveguide type diffraction grating device 121. Each thin film heater 122ₙ generates heat when current is supplied thereto from the temperature controller 123, thus heating the predetermined region in contact therewith, thereby adjusting the optical path length of the predetermined region.

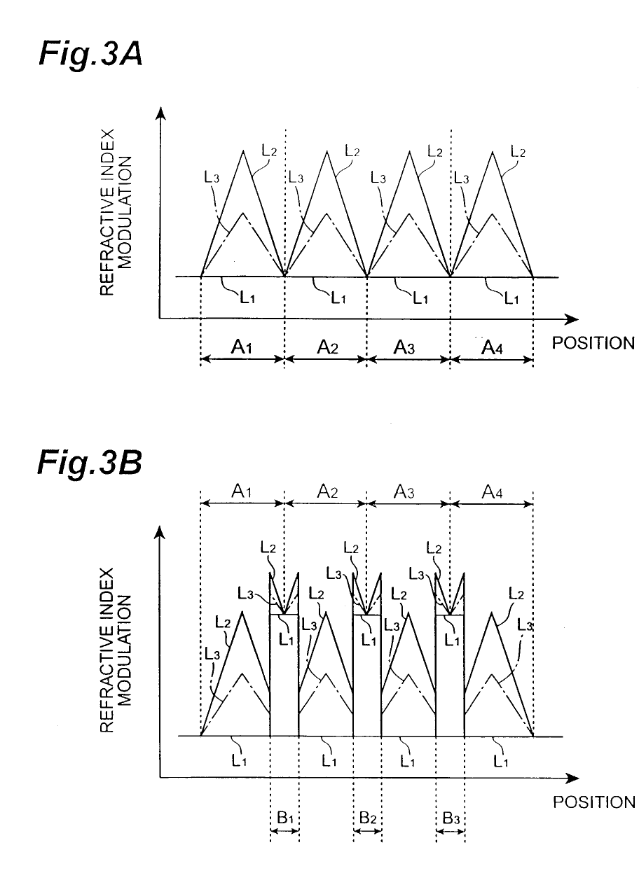

FIGS. 3A and 3B are charts showing respective states of refractive index modulation in the optical waveguide type diffraction grating device 121 of the optical component 120 in accordance with this embodiment. FIG. 3A shows the state of refractive index modulation in the case where no temperature adjustment is effected by any of the thin film heaters 122₁ to 122₃, as with FIG. 2B. On the other hand, FIG. 3B shows the state of refractive index modulation in the case where temperature is adjusted by all of the thin film heaters 122₁ to 122₃. Each of FIGS. 3A and 3B shows lines L₁ connecting minimal points of refractive index modulation, lines L₂ connecting maximum points of refractive index modulation, and lines L₃ indicating the distribution of average refractive index.

In the case with temperature adjustment (FIG. 3B), as can be seen when compared with the case without temperature adjustment (FIG. 3A), the region Bₙ including the boundary position between the refractive index modulation forming. areas Aₙ and Aₙ₊₁ in the optical waveguide type diffraction grating device 121 is heated by the thin film heater 122ₙ, whereby each of the lines L₁ connecting minimal points of refractive index modulation, lines L₂ connecting maximum points of refractive index modulation, and lines L₃ indicating the distribution of average refractive index is raised therein. Namely, the optical path length of the region Bₙ is regulated by temperature adjustment.

Preferably, each predetermined region Bₙ in the optical waveguide type diffraction grating device 121 does not include the position where refractive index modulation is maximized in each refractive index modulation forming area Aₙ as depicted. When the individual refractive index modulation forming areas Aₙ are disposed at predetermined intervals, it is preferred that each predetermined region Bₙ in the optical waveguide type diffraction grating device 121 deviate from each refractive index modulation forming area Aₙ and be free from refractive index modulation.

In the optical encoder including such an optical component 120, a predetermined wavelength of pulsed light satisfying a Bragg condition in the optical waveguide type diffraction grating device 121 is fed into the first end 111 of the optical circulator 110. The pulsed light inputted to the first end 111 of the optical circulator 110 is outputted from the second end 112, so as to be fed into the optical waveguide type diffraction grating device 121 of the optical component 120. Of the pulsed light fed into the optical waveguide type diffraction grating device 121, a first part is reflected by the refractive index modulation forming area Al in the first stage, a second part is reflected by the refractive index modulation forming area A₂ in the second stage, a third part is reflected by the refractive index modulation forming area A₃ in the third stage, and a fourth part is reflected by the refractive index modulation forming area A₄ in the fourth stage. Thus reflected individual parts of pulsed light are fed into the second end 112 of the optical circulator 110, and are outputted from the third end 113. The first to fourth pulsed light components reflected by the refractive index modulation forming areas A₁ to A₄ in the optical waveguide type diffraction grating device 121 and outputted from the third end 113 of the optical circulator 110 have phase shift amounts regulated by the optical path length adjustment of each region Bₙ upon temperature adjustment. Namely, with respect to the pulsed light inputted, the first to fourth pulsed light components outputted are encoded with the respective codes corresponding to the phase shift amounts.

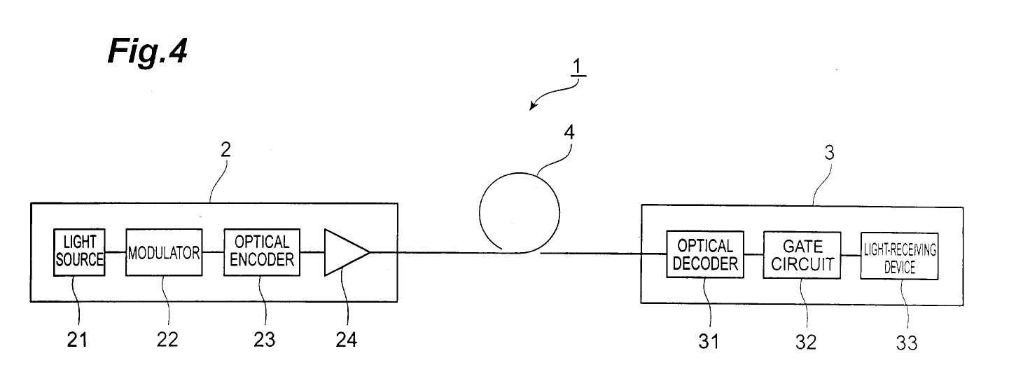

An embodiment of the optical communication system in accordance with the present invention will now be explained. FIG. 4 is a diagram of the optical communication system 1 in accordance with this embodiment. This optical communication system 1 comprises an optical transmitter 2 and an optical receiver 3, whereas an optical fiber transmission line 4 is laid between the optical transmitter 2 and the optical receiver 3. The optical transmitter 2 has a light source 21, a modulator 22, an optical encoder 23, and an optical amplifier 24. The optical receiver 3 has an optical decoder 31, a gate circuit 32, and a light-receiving device 33. Each of the optical encoder 23 and optical decoder 31 has the same configuration as that of the optical encoder 100 in accordance with the embodiment mentioned above.

The optical transmitter 2 is provided with a plurality of sets of light sources 21, modulators 22, and optical encoders 23, whereas respective encoded signal light components outputted from the optical encoders 23 in the individual sets are multiplexed, and thus multiplexed encoded signal light is optically amplified by the optical amplifier 24. On the other hand, the optical receiver 3 is provided with a plurality of sets of optical decoders 31, gate circuits 32, and light-receiving devices 33, whereby the multiplexed encoded signal light is divided into individual encoded signal light components, which are then fed into the respective optical decoders 31. Such a configurational lows the optical communication system 1 to carry out the OCDM transmission.

The light source 21 in the optical transmitter 2 continuously oscillates laser light, for which a semiconductor laser light source is used, for example. The modulator 22 inputs therein not only the laser light outputted from the light source 21 but also an electric pulse signal carrying information to be transmitted, modulates the laser light with the electric pulse signal, and outputs thus modulated laser light as signal light. The optical encoder 23 inputs therein the signal light outputted from the modulator 22, encodes this signal light, and outputs thus encoded signal light. The optical amplifier 24 inputs therein the encoded signal light outputted from the optical encoder 23, optically amplifies the encoded signal light, and sends out thus optically amplified encoded signal light to the optical fiber transmission line 4.

The optical decoder 31 in the optical receiver 3 inputs therein the encoded signal light having arrived after propagating through the optical fiber transmission line 4, decodes the encoded signal, and outputs thus decoded signal light. The gate circuit 32 inputs there in the light outputted from the optical decoder 31, and opens only during periods when the light contains signal light components but closes during periods when the light contains only noise components, thereby reducing noise. The gate circuit 32 includes a semiconductor saturable absorber, for example. The light-receiving device 33 inputs therein signal light outputted from the gate circuit 32, receives this signal light, photoelectrically converts the signal light into an electric pulse signal, and outputs the electric pulse signal. For example, a photodiode is used therefor.

If the same code is used upon encoding and decoding in the optical encoder 23 and optical decoder 31, the signal light outputted after being decoded by the optical decoder 31 will be one reconstituting the signal light before being encoded by the optical encoder 23. If the code used upon encoding in the optical encoder 23 differs from that used upon decoding in the optical decoder 31, however, the light outputted after being decoded by the optical decoder 31 contains only the noise components, thus failing to reconstitute the signal light before being encoded by the optical encoder 23.

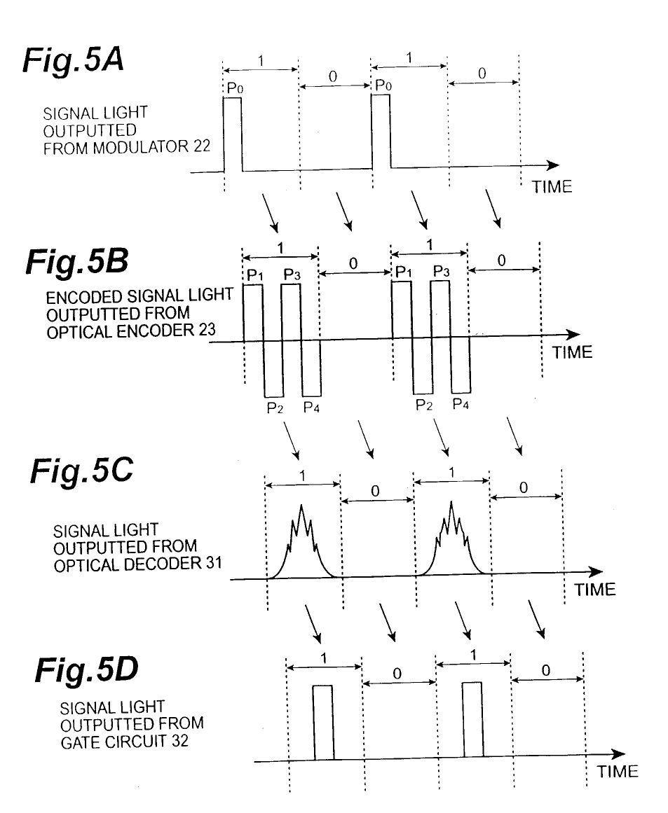

FIG. 5 is a chart showing respective waveforms of light outputted from the modulator 22, optical encoder 23, optical decoder 31, and gate circuit 32 in the optical communication system 1 in accordance with this embodiment. The signal light outputted from the modulator 22 ((a) in FIG. 5) has the same waveform as that of the electric pulse signal for externally modulating the laser light outputted from the light source 21. In this chart, the modulator 22 outputs 4-bit data in the sequence of “1010”, whereby pulsed light P₀ is outputted only when the bit is at a value of 1.

The encoded signal light outputted from the optical encoder 23 ((b) in FIG. 5) is one obtained upon encoding the signal light outputted from the modulator 22 ((a) in

FIG. 5). The pulsed light P₀ outputted from the modulator 22 is resolved by the optical encoder 23 into four pulsed light components P₁ to P₄. Here, in the optical component 120 included in the optical decoder 23 (having the same configuration as that of the optical encoder 100), each of the regions B₁ to B₃ Of the optical waveguide type diffraction grating device 121 is heated, so as to adjust their optical path lengths, whereby the phase of refractive index modulation amplitude function is inverted between each pair of refractive index modulation forming areas Aₙ and Aₙ₊₁ adjacent each other in the optical waveguide type diffraction grating device 121. As a consequence, the respective phases of pulsed light components P₂, P₄ differ from those of pulsed light components P₁, P₃ by Π. Namely, if the bit is at a value of 1, the encoded signal light (four pulsed light components P₁ to P₄) outputted from the optical encoder 23 is one obtained upon encoding the pulsed light P₀ with a code (0, Π, 0, Π).

The signal light outputted from the optical decoder 31 ((c) in FIG. 5) is one obtained upon decoding the encoded signal light outputted from the optical encoder 23 ((b) in FIG. 5). When the bit is at a value of 1, the encoded signal light components outputted from the optical encoder 23 (four pulsed light components P₁ to P₄) are sequentially fed into the optical decoder 31 (having the same configuration as that of the above-mentioned optical encoder 100). For each of the pulsed light components P₁ to P₄, an operation similar to that in the optical encoder 23 is carried out in the optical decoder 31, and their interfering results are outputted from the optical decoder 31. The power of light thus outputted from the optical decoder 31 indicates the correlation between the respective codes of the optical encoder 23 and optical decoder 31. Therefore, if their codes are identical to each other, the signal light outputted after being decoded by the optical decoder 31 will be one reconstituting the signal light before being encoded by the optical encoder 23. If their codes differ from each other, by contrast, the light outputted after being decoded by the optical decoder 31 will not attain a correlation peak of a threshold or higher, thus failing to reconstitute the signal light before being encoded by the optical encoder 23.

The signal light outputted from the gate circuit 32 ((d) in FIG. 5) is one obtained by transmitting the light outputted from the optical decoder 31 ((c) in FIG. 5) therethrough only during periods when it contains signal light components, where by noise is reduced. As shown in this chart, if the respective codes of the optical encoder 23 and optical decoder 31 are identical to each other while the bit is at a value of 1, the gate circuit 32 outputs pulsed light. If the respective codes of the optical encoder 23 and optical decoder 31 differ from each other or if the bit is at a value of 0, by contrast, no pulsed light is outputted from the gate circuit 32. In the foregoing manner, the OCDM transmission is carried out between the optical transmitter 2 and the optical receiver 3.

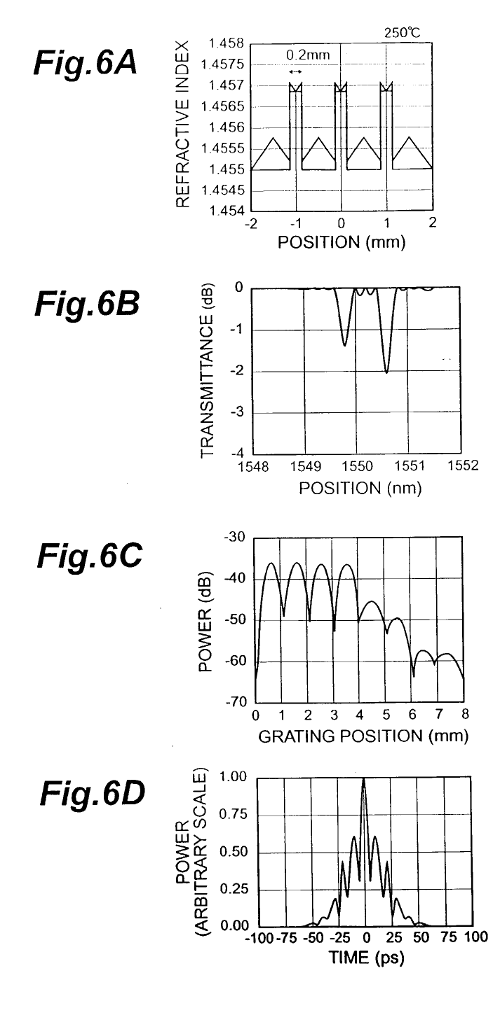

More specific examples will now be explained. FIGS. 6A to 6D, 7A to 7D, 8A to 8D, 9A to 9D, and 10A to 10D are charts showing refractive index modulation distributions, transmission characteristics, pulse response waveforms, and correlation waveforms of the optical waveguide type diffraction grating device 121 in the optical component 120. FIGS. 6A, 7A, 8A, 9A, and 10 A show refractive index modulation distributions of the optical waveguide type diffraction grating device 121. FIGS. 6B, 7B, 8B, 9B, and 10B show transmission characteristics of the optical waveguide type diffraction grating device 121. FIGS. 6C, 7C, 8C, 9C, and 10C show pulse response waveforms of the optical waveguide type diffraction grating device 121. FIGS. 6D, 7D, 8D, 9D, and 10D show correlations between the code (0, Π, 0, Π) realized in the optical waveguide type diffraction grating device 121 and the code (0, Π, 0, Π) realized in an optical waveguide typed if fraction grating device in which phase-inverted parts are initially formed between four refractive index modulation forming areas. Each refractive index modulation forming area Aₙ of the optical waveguide type diffraction grating device 121 has a length of 1 mm.

As shown in FIGS. 6A, 7A, 8A, 9A, and 10A, each region Bₙ of the optical waveguide type diffraction grating device 21 is heated by thin film heaters 122, so as to increase the average refractive index. Among sets of FIGS. 6A to 6D, 7A to 7D, 8A to 8D, 9A to 9D, and 10A to 10D, the length of each region Bₙ in the optical waveguide type diffraction grating device 121 varies, and the amount of temperature rise in each region Bₙ fluctuates. However, in each of sets of FIGS. 6A to 6D, 7A to 7D, 8A to 8D, 9A to 9D, and 10A to 10D, the phase of refractive index modulation amplitude function is reversed between each pair of the adjacent refractive index modulation forming areas Aₙ and Aₙ₊₁ in the optical waveguide type diffraction grating device 121. Namely, the code used for encoding/decoding in the optical encoder/decoder including the optical component 120 is (0, Π, 0, Π).

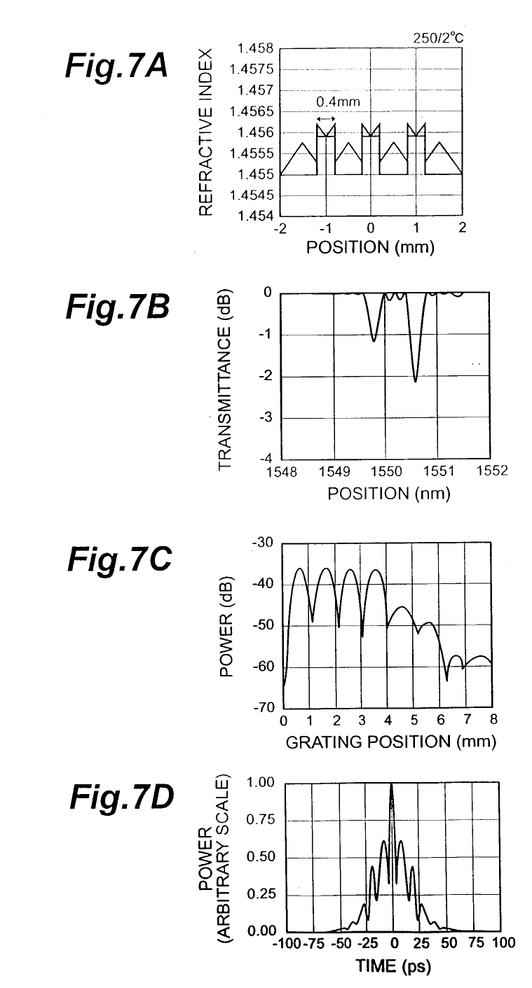

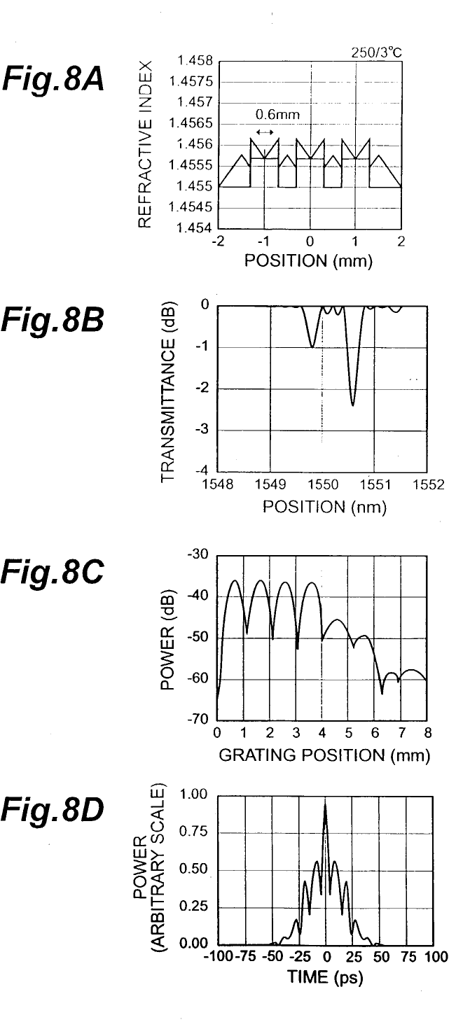

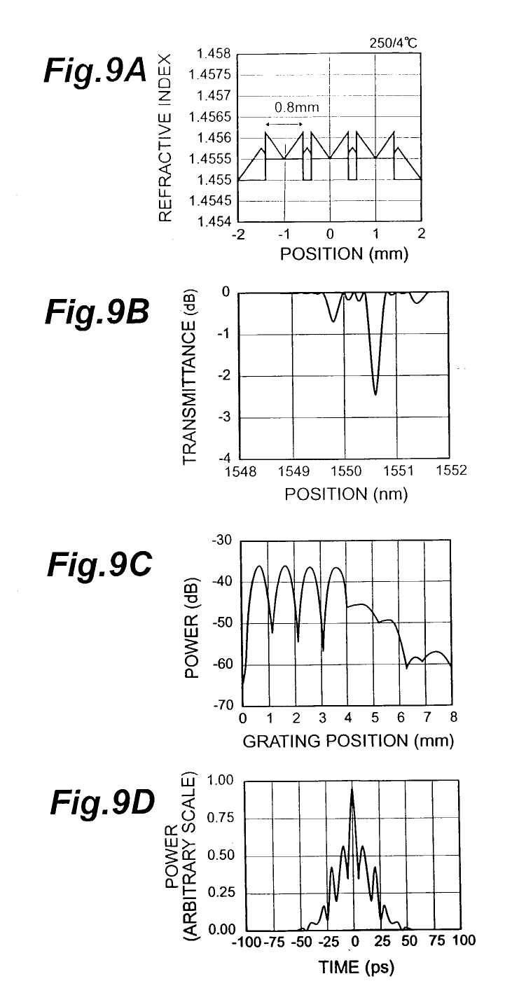

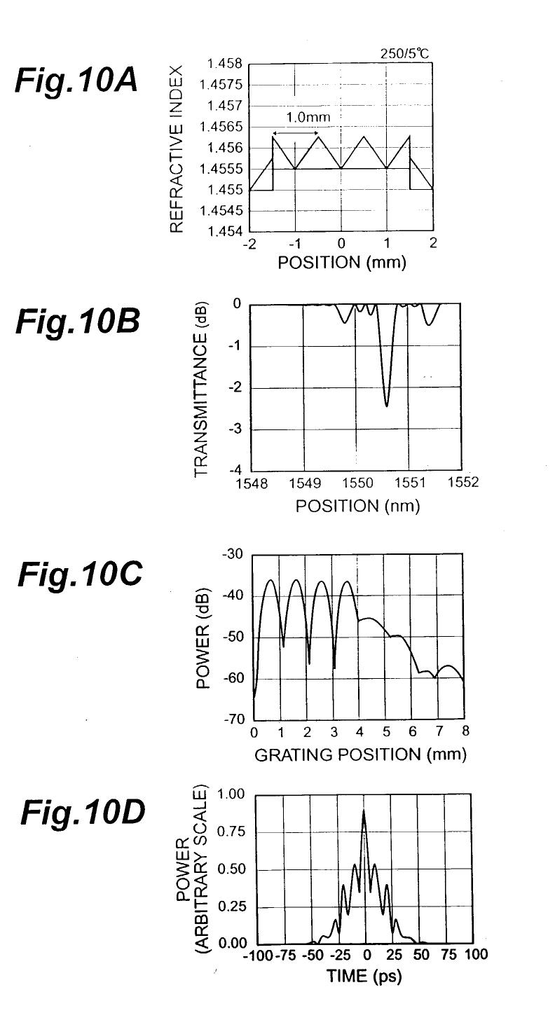

FIGS. 6A to 6D show the case where the length of each region Bₙ is 0.2 mm while the amount of temperature rise in each region Bₙ is 250° C. FIGS. 7A to 7D show the case where the length of each region Bₙ is 0.4 mm while the amount of temperature rise in each region Bₙ is 125° C. (=250° C./2). FIGS. 8A to 8D show the case where the length of each region Bₙ is 0.6 mm while the amount of temperature rise in each region Bₙ is 83° C. (=250° C./3). FIGS. 9A to 9D show the case where the length of each region Bₙ is 0.8 mm while the amount of temperature rise in each region Bₙ is 63° C. (=250° C./4). FIGS. 10A to 10D show the case where the length of each region Bₙ is 1.0 mm while the amount of temperature rise in each region Bₙ is 50° C. (=250° C./5) As can be seen when FIGS. 6B 7B, 8B, 9B, and 10B are compared with each other, the optical waveguide type diffraction grating device 121 has such transmission characteristics that the loss peak wavelength is the same even when the length and temperature rise amount in each region Bₙ vary, although their loss peak values are different from each other. As can be seen when FIGS. 6C, 7C, 8C, 9C, and 10C are compared with each other, the optical waveguide type diffraction grating device 121 yields substantially the same pulse response waveform even when the length and temperature rise amount in each region Bₙ vary, whereby four large peaks corresponding to the above-mentioned pulsed light components P₁ to P₄ and some smaller peaks subsequent thereto are seen. As can be seen when FIGS. 6D, 7D, 8D, 9D, and 10D are compared with each other, the correlation of codes is strong even when the length and temperature rise amount in each region Bₙ vary, whereby encoding/decoding processes can be carried out normally. The smaller peaks seen in FIGS. 6C, 7C, 8C, 9C, and 10C are generated when Bragg reflection is repeated at least three times in any of the refractive index modulation forming are as A₁ to A₄ in the optical waveguide type diffraction grating device 121, whereas their power is so low that their influence on the encoding/decoding processes is weak.

When each region Bₙ of the optical waveguide type diffraction grating device 121 had a length of 1.0 mm as in the case shown in FIGS. 10A, 10B, 10C, and 10D, at least one of the regions B₁ to B₃ was heated or none of the regions B₁ to B₃ was heated, so as to realize various codes, whereby autocorrelations between identical codes or cross-correlations between different codes were verified. As a result, large peaks were seen in the autocorrelations between identical codes. The maximum peak seen in cross-correlations between different codes was smaller than the second peak seen in the autocorrelations between identical codes. Therefore, even when each region Bₙ of the optical waveguide type diffraction grating device 121 has a length of 1.0 mm as in the case shown in FIGS. 10A to 10D, the optical encoder/decoder including such an optical waveguide type diffraction grating device 121 can carry out encoding/decoding processes normally.

As in the foregoing, the optical component 120 in accordance with this embodiment can reverse the phase of refractive index modulation amplitude function between a pair of adjacent refractive index modulation forming areas Aₙ and Aₙ₊₁ in the optical waveguide type diffraction grating device 121 due to the actions of the thin film heater 122 and temperature controller 123. As a consequence, the code used upon encoding/decoding is variable in the optical encoder/decoder including the optical component 120 in accordance with this embodiment. Also, the optical encoder/decoder including the optical component 120 in accordance with this embodiment can be made smaller since the number of constituent parts is small in the optical encoder/decoder including the optical component 120 in accordance with this embodiment.

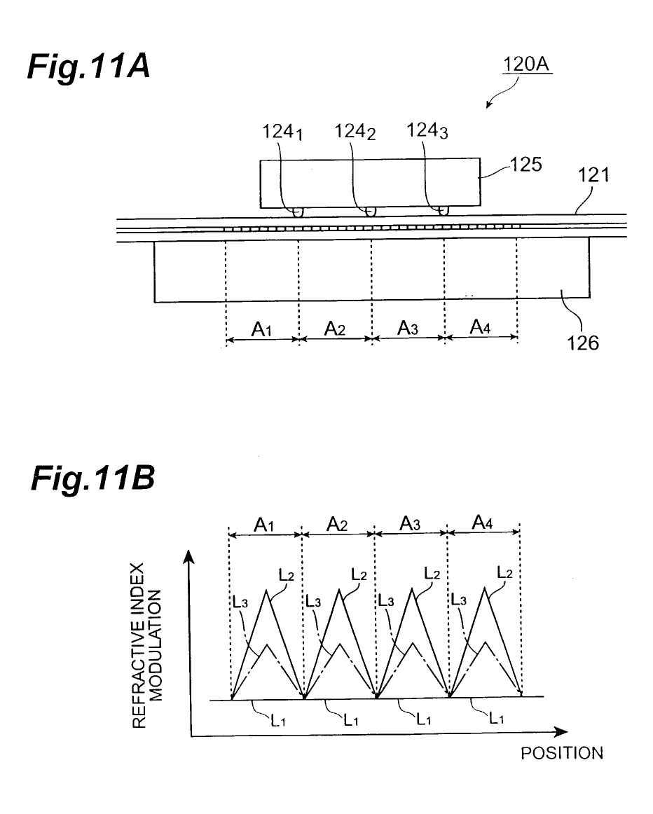

The optical component 120A in accordance with another embodiment will now be explained. FIGS. 11A and 11B are explanatory views for the optical component 120A in accordance with this embodiment. This optical component 120A comprises an optical waveguide type diffraction grating device 121, side pressure applying parts 124₁ to 124₃, a tension controller 125, and a housing 126. FIG. 11A shows the configuration of the optical component 120A. FIG. 11B shows the state of refractive index modulation in the optical waveguide type diffraction grating device 121. This optical waveguide type diffraction grating device 121 is similar to that shown in FIG. 2B.

The optical waveguide type diffraction grating device 121 is secured to the housing 126 having an elasticity. The side pressure applying parts 124, to 1243 and the tension controller 125 act as optical path length adjusting means for adjusting the optical path length of a predetermined region including the boundary position between the refractive index modulation forming areas Aₙ and Aₙ₊₁ in the optical waveguide type diffraction grating device 121 (n=1 to 3). Namely, each side pressure applying section 124ₙ includes a piezoelectric device, for example, and has an end part in contact with a predetermined region including the boundary position between the refractive index modulation forming areas Aₙ and Aₙ₊₁ in the optical waveguide type diffraction grating device 121. Under the control of the tension controller 125, each side pressure applying part 124ₙ applies a side pressure to the predetermined region so as to impart a tension thereto, thereby adjusting the optical path length of the predetermined region.

In such an optical component 120A, the reciprocating optical path length L of a predetermined region to which a tension is applied by each side pressure applying section 124ₙ is represented by the following expression:

L=2nd (1)

where d is the length of the predetermined region, and n is the effective refractive index thereof. The dependence of the optical path length L on tension g is represented by the following set of expressions:

$$\begin{matrix}\frac{ⅆ L}{ⅆ g} = 2 d \frac{\partial n}{\partial g} + 2 n \frac{\partial d}{\partial g} = L ( \frac{1}{n} \frac{\partial n}{\partial g} + \frac{1}{d} \frac{\partial d}{\partial g} ) ≡ α L & \text{(2a)} \\ α ≡ \frac{1}{n} \frac{\partial n}{\partial g} + \frac{1}{d} \frac{\partial d}{\partial g} & \text{(2b)}\end{matrix}$$

It has experimentally been verified that the value of parameter α appearing in this set of expressions is 1.3×10⁻⁵.

When the optical path length L is ½ of the wavelength λ, a phase inversion can be realized. Namely, assuming that the tension for causing the optical path length L to become ½ of the wavelength λ is Δg, a phase inversion can be realized if the expression of

$$\frac{ⅆ L}{ⅆ g} Δ g = α L \cdot Δ g = \frac{λ}{2} \qquad ( 3 )$$

holds. This expression (3) indicates it sufficient if the tension Δg represented by the expression of

$$Δ g = \frac{λ}{2 α L} = \frac{1}{2.6 \times {10}^{- 5}} \frac{λ}{L} \qquad ( 4 )$$

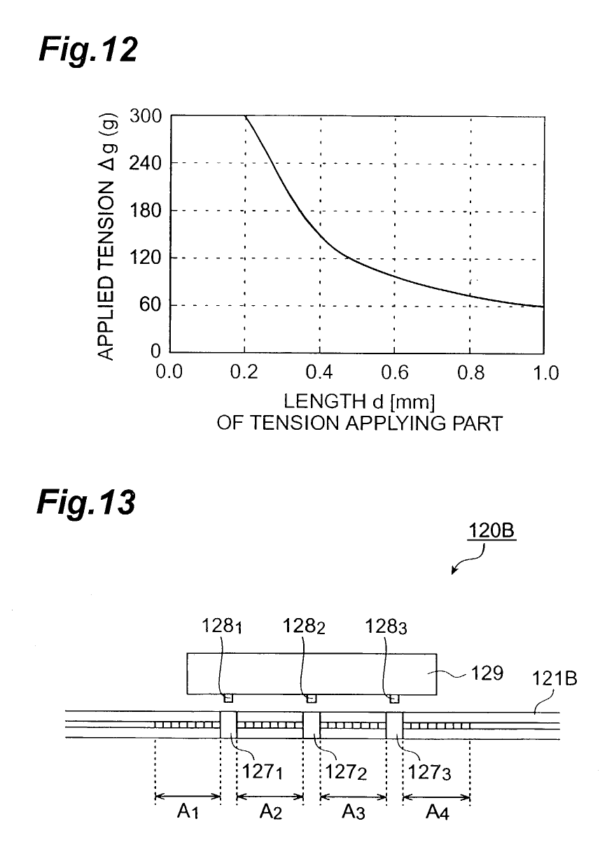

is applied to a predetermined region of the optical waveguide type diffraction grating device 121. As shown in FIG. 12, the tension Δg for realizing a phase inversion is inversely proportional to the length d of the predetermined region to which the tension is applied.

The optical component 120B in accordance with still another embodiment will now be explained. FIG. 13 is an explanatory view for the optical component 120B in accordance with this embodiment. The optical component 120B comprises an optical waveguide type diffraction grating device 121B, light sources 128₁ to 128₃, and a light source controller 129. In the optical waveguide type diffraction grating device 121B, a refractive index variable member 127, is inserted between the refractive index modulation forming areas Aₙ and Aₙ₊₁.

The refractive index variable members 127₁ to 127₃, light sources 128₁ to 128₃, and light source controller 129 act as optical path length adjusting means for adjusting the optical path length of a predetermined region between the refractive index modulation forming areas Aₙ and Aₙ₊₁ in the optical waveguide type diffraction grating device 121B (n=1 to 3). Namely, each refractive index variable member 127ₙ changes its refractive index when irradiated with a predetermined wavelength of light, and is constituted by a photochromic material or photo refractive material, for example. Under the control of the light source controller 129, each light source 128ₙ irradiates its corresponding refractive index variable member 127ₙ with a predetermined wavelength of light, so as to change the refractive index of the refractive index variable member 127ₙ, thereby adjusting the optical path length of the predetermined region.

The refractive index variable member inserted between the refractive index modulation forming areas Aₙ and Aₙ₊₁ may be one (e.g., liquid crystal) adapted to change its refractive index when an electric field is applied thereto. In this case, in place of the light sources 128₁ to 128₃ and light source controller 129, electrodes for applying an electric field are disposed so as to hold the refractive index variable member therebetween.

Without being restricted to the above-mentioned embodiments, the present invention can be modified in various manners. For example, while the optical waveguide type diffraction grating device included in the optical component has four refractive index modulation forming areas in the above-mentioned embodiments, it may have a greater number of refractive index modulation forming areas as well. Also, though the lines L₁ connecting minimal points of refractive index modulation are flat whereas the lines L₂ connecting maximum points of refractive index modulation yield triangular forms in the above-mentioned embodiments, each of the lines L₁ and L₂ may have any form.

In the optical component in accordance with the present invention, as explained in detail in the foregoing, the optical path length of a predetermined region including a part of a region between the n-th and (n+1)-th refractive index modulation forming areas adjacent each other in the first to N-th refractive index modulation forming areas in the optical waveguide type diffraction grating device is adjusted by optical path length adjusting means, whereby the phase of refractive index modulation amplitude function can be reversed between the n-th and (n+1)-th refractive index modulation forming areas adjacent each other.

In the optical encoder in accordance with the present invention including this optical component, pulsed light fed into the first end of the optical circulator is outputted from the second end thereof, so as to be reflected by each of the first to N-th refractive index modulation forming areas in the optical waveguide type diffraction grating device of the optical component connected to the second end. The first to N-th pulsed light components respectively reflected by the first to N-th refractive index modulation forming areas are fed into the second end of the optical circulator and then is outputted from the third end. Here, in the optical waveguide type diffraction grating device of the optical component, the optical path length of a predetermined region including a part of a region between the n-th and (n+1)-th refractive index modulation forming areas adjacent each other in the first to N-th refractive index modulation forming areas is adjusted by optical path length adjusting means. Therefore, in the optical encoder, the first to N-th pulsed light components outputted are those obtained upon encoding the pulsed light inputted, whereas the codes at that time correspond to the phase inversion based on the optical path length of the predetermined region adjusted by the optical path length adjusting means.

In the optical decoder in accordance with the present invention including the above-mentioned optical component, the first to N-th pulsed light components outputted from the optical encoder are inputted and decoded. If the same code is used upon the encoding and decoding processes in the optical encoder and decoder, the original signal is reconstituted by the optical decoder. The optical communication system in accordance with the present invention comprises the optical transmitter having the optical encoder in accordance with the present invention and the optical receiver having the optical decoder in accordance with the present invention, thereby being able to carry out the OCDM transmission.

Thus, codes used upon encoding/decoding are variable in accordance with the present invention. Also, the optical encoder and decoder can be made smaller in size since the number of their constituent parts is smaller.

What is claimed is:

1. An optical component comprising an optical waveguide type diffraction grating device successively provided with first to N-th refractive index modulation forming areas, each Bragg-reflecting a predetermined wavelength of guided wave, along a longitudinal direction of an optical waveguide; and
optical path length adjusting means for adjusting an optical path length of a predetermined region including a part of a region between the n-th and (n+1)-th refractive index modulation forming areas adjacent each other in said first to N-th refractive index modulation forming areas in said optical waveguide type diffraction grating device, where N is an integer of at least 2, and n is an integer of at least 1 but not greater than (N−1).

2. An optical component according to claim 1, wherein said optical path length adjusting means adjusts the optical path length of said predetermined region in said optical waveguide type diffraction grating device by regulating a temperature of said predetermined region.

3. An optical component according to claim 1, wherein said optical path length adjusting means adjusts the optical path length of said predetermined region in said optical waveguide type diffraction grating device by regulating a tension of said predetermined region.

4. An optical component according to claim 1, wherein said optical path length adjusting means adjusts the optical path length of said predetermined region in said optical waveguide type diffraction grating device by regulating a refractive index of a refractive index variable member provided in said predetermined region.

5. An optical component according to claim 1, wherein said predetermined region in said optical waveguide type diffraction grating device is formed with no refractive index modulation.

6. An optical component according to claim 1, wherein said predetermined region in said optical waveguide type diffraction grating device deviates from a position where refractive index modulation is maximized in said first to N-th refractive index modulation forming areas.

7. An optical encoder comprising:
an optical circulator having first, second, and third ends, outputting from said second end light fed into said first end, and outputting from said third end light fed into said second end; and
the optical component according to claim 1 connected to said second end of said optical circulator;
said optical encoder encoding signal light fed into said first end of said optical circulator and outputting said encoded signal light from said third end of said optical circulator.

8. An optical decoder comprising:
an optical circulator having first, second, and third ends, outputting from said second end light fed into said first end, and outputting from said third end light fed into said second end; and
the optical component according to claim 1 connected to said second end of said optical circulator;
said optical decoder decoding encoded signal light fed into said first end of said optical circulator and outputting said decoded signal light from said third end of said optical circulator.

9. An optical communication system comprising:
an optical transmitter having the optical encoder according to claim 7, encoding signal light with said optical encoder, and sending out said encoded signal light; and
an optical receiver having the optical decoder according to claim 8, decoding encoded signal light having arrived, and receiving said decoded signal light.
